(19) United States
(12) Patent Application Publication
(10) Pub. No.: US 2009/0022618 A1
(43) Pub. Date: Jan. 22, 2009

(54) Damping Alloy Steel Sheet and Method for Producing the Same

(75) Inventors: Koichiro Fujita, Chiba (JP); Tadashi Inoue, Fukuyama (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: JFE STEEL CORPORATION, Chiyoda-ku, Tokyo (JP)

(21) Appl. No.: 12/223,480

(22) PCT Filed: Feb. 6, 2007
(86) PCT No.: PCT/JP2007/052435

§ 371 Date: Aug. 6, 2008

(30) Foreign Application Priority Data
Feb. 21, 2006 (JP) 2006-043711
Oct. 31, 2006 (JP) 2006-295514

(51) Int. Cl. C22C 38/00; C22C 38/06; C22C 38/04; C21D 8/02

(52) U.S. Cl. 420/87; 420/103; 420/120; 420/128; 148/645

(57) ABSTRACT

Provided are a steel-based damping alloy steel sheet having a thickness of 2.0 mm or less which has an excellent damping property of a loss factor of 0.030 or more, and excellent workability, without requiring plenty of elements such as Al, Si, and Cr; and a method for producing the same. Further provided is a damping alloy steel sheet having a thickness of 2.0 mm or less which has an element composition of C: 0.005% or less, Si: less than 1.0%, Mn: 0.05 to 1.5%, P: 0.2% or less, S: 0.01% or less, Sol. Al: less than 1.0%, and N: 0.005% or less, in terms of % by mass, and the remainder containing Fe and inevitable impurities, an average grain diameter of 50 to 300 μm, a maximum permeability of 4,000 or more, and a residual induction of 1.10 T or less.

### TECHNICAL FIELD

The present invention relates to a steel-based damping alloy steel sheet which has excellent damping capacity without requiring plenty of additive elements, and a method for producing the same.

### BACKGROUND ART

The need of reducing noise and vibration is increasing in a field such as automobiles and electrical machinery which use a steel sheet (thin plate) having a thickness of 2.0 mm or less, in addition to a conventional field such as shipping, bridge, industrial machinery and construction which use mainly a steel plate. Consequently, various measures have been taken. One of the measures is a material damping. The material damping is a way of reducing (damping) vibration by converting vibration energy into thermal energy in a material thereby losing the vibration energy.

As a damping material for the material damping, there is a constrained layer type damping steel sheet in which a resin is sandwiched between steel sheets. The constrained layer type damping steel sheet has a damping effect by shear strain of resin, and is high in loss factor which is an index of damping capacity, and is actually used in various places great in number of actual use. However, since it has problems of having low productivity and poor weldability and workability, its application is limited.

Meanwhile, as a steel-based damping material excellent in weldability and workability, there is a ferromagnetic type damping alloy employing hysteresis of domain wall movement. For instance, Patent Documents 1 to 3 disclose high alloys added with over 1% of at least one element selected from ferrite former elements such as Al, Si, and Cr. A purpose of adding such ferrite former can be summarized in two points:

i) improving a loss factor by raising a magnetostriction constant, and

ii) growing crystal grains by controlling reverse transformation to austenite upon high temperature annealing, thereby improving the loss factor. However, the addition of these elements is not preferable as it leads to increase in the production cost and low productivity. Also, it is not preferable because the grain coarse growth gives rise to problems such as decreased toughness and occurrence of orange peel in working, though the loss factor is improved. In addition, when the ferrite former is added to a sheet, a peculiarity texture is formed while hot rolling, and a surface defect called ridging is caused.

Patent Documents 4 to 8 disclose a damping alloys or constrained layer type damping steel sheets which have a relatively small amount of Al, Si or Cr. However, such technique cannot always give a sheet having a high loss factor, excellent workability, and a thickness of 2.0 mm or less.

Among Patent Documents described above, only Patent Document 2 covers a sheet having a thickness of 2.0 mm or less, and knowledge about a ferromagnetic type damping alloy can hardly be obtained in the field of a sheet.

Patent Document 1: Japanese Unexamined Patent Publication No. 4-99148

Patent Document 2: Japanese Unexamined Patent Publication No. 52-73118

Patent Document 3: Japanese Unexamined Patent Publication No. 2002-294408

Patent Document 4: Japanese Unexamined Patent Publication No. 2000-96140

Patent Document 5: Japanese Unexamined Patent Publication No. 10-140236

Patent Document 6: Japanese Unexamined Patent Publication No. 9-143623

Patent Document 7: Japanese Unexamined Patent Publication No. 9-176780

Patent Document 8: Japanese Unexamined Patent Publication No. 9-104950

### DISCLOSURE OF THE INVENTION

The present invention has been made under these circumstances, and an object of the invention is to provide a steel-based damping alloy steel sheet having favorable damping capacity, and excellent workability, which has a thickness of 2.0 mm or less and a loss factor of 0.030 or more, with no need of plenty of elements such as Al, Si, and Cr, and a method for producing the same.

The present inventors have conducted intensive studies about damping capacity of a steel-based ferromagnetic type damping alloy steel sheet, and as a result, they have found that a steel-based damping alloy steel sheet which has a high loss factor of 0.030 or more can be obtained by controlling a grain diameter, maximum permeability, and residual induction, without adding plenty of alloy element such as Al, Si and Cr.

The present invention has been made on the basis of such knowledge, and provides a damping alloy steel sheet which has a thickness of 2.0 mm or less;

element composition of C: 0.005% or less, Si: less than 1.0%, Mn: 0.05 to 1.5%, P: 0.2% or less, S: 0.01% or less, Sol. Al: less than 1.0%, N: 0.005% or less, in terms of % by mass, and the remainder including Fe and inevitable impurities;

an average grain diameter of 50 to 300 μm;

maximum permeability of 4,000 or more; and

residual induction of 1.10 T or less.

It is preferable that at least one condition of Si: 0.5 or more to less than 1.0%, P: 0.05 to 0.2%, S: 0.002% or less be satisfied in the above element composition.

The damping alloy steel sheet of the invention can be produced by, for example, the method in which steel having the element composition described above is hot-rolled, cold-rolled after pickling, and heated at a temperature of recrystallization temperature or higher to lower than an Ac₁ transformation point upon the continuous annealing, so as to give an average grain diameter of 50 to 300 μm; and cooled under tension of 0.1 to 4.9 MPa to give the maximum permeability of 4,000 or more and the residual induction of 1.10 T or less.

The present invention can provide a steel-based damping alloy steel sheet which has a high loss factor of 0.030 or more and excellent workability without adding plenty of alloy elements such as Al, Si and Cr. Also, the damping alloy steel sheet according to the invention is suitable for applications of using a sheet having a thickness of 2.0 mm or less such as in the field of automobiles and electrical machinery.

### BRIEF DESCRIPTION OF THE DRAWING

FIG. 1 is a graph showing a relationship between the tension and the loss factor upon annealing and cooling.

### BEST MODE FOR CARRYING OUT THE INVENTION

The steel-based damping alloy steel sheet of the present invention is characterized in that a domain wall is effectively moved upon giving vibration and a high damping capacity is thus obtained without a high magnetostriction constant or extreme coarse grained texture. Due to this, the point of the invention is to reduce residual stress in a grain and plastic strain which make it difficult to move a domain wall. In the case where the residual stress exists, since a magnetic domain structure freezes to ease the residual stress, the domain wall does not move effectively upon giving vibration, and thereby the damping capacity decreases. In the case where the plastic strain exists, since the plastic strain impedes the movement of the domain wall, the domain wall does not move effectively upon giving vibration, and thereby the damping capacity decreases.

The present inventors have conducted studies from the viewpoints of avoiding the freeze of magnetic domain structure and reducing the plastic strain, with regard to the loss factor of the steel-based damping alloy steel sheet having less than 1% of the alloy component such as Al and Si which is a ferrite former. Consequently, as described above, they have found that the loss factor is closely related with the maximum permeability and the residual induction. Hereinafter, the present invention is illustrated in detail.

(1) Component (following ‘%’ is referred to ‘% by mass’)

C: when C content is over 0.005%, carbide is formed and impedes the movement of the domain wall. Accordingly, the C content is 0.005% or less, and preferably 0.003% or less.

Si: Si does not have to be encouragingly added for obtaining excellent damping capacity and excellent workability which are tasks of the invention, and it is fine to be added at an amount as little as inevitable impurities (may also be 0%). Meanwhile, since Si is a highly effective element for enhancing the strength of steel sheet by solid solution strengthening, Si can be suitably added according to a desired strength. However, when the Si content is 1.0% or more, the productivity is impeded, the cost increases, and thus ridging readily occurs. Therefore, the Si content needs to be less than 1.0%. Further, since a grain diameter of a steel sheet according to the invention is 50 μm or more, if Si is not encouragingly added, the steel sheet becomes exceedingly soft and its lower yield point becomes less than 170 MPa, which may cause poor handleability, that is, a problem that the sheet is deformed when handling (when dealing). As a consequence, it is preferable to set the lower yield point to be 170 MPa or more, and thus it is preferable to set the Si content to be 0.5% or more.

Mi: Mi is an element which forms sulfide and improves hot brittleness, and also is a solid solution strengthening element.

Therefore, the Mn content needs to be 0.05% or more. Meanwhile, since addition of a large quantity of Mn deteriorates workability, the upper limit of the Mn content is 1.5%.

P: P does not have to be encouragingly added for obtaining excellent damping capacity and excellent workability which are tasks of the invention, and it is fine to be added at an amount as little as inevitable impurities (may also be 0%). Meanwhile, since P is a highly effective element for enhancing the strength of a steel sheet by solid solution strengthening, P can be suitably added according to a desired strength. However, when the P content is over 0.2%, the workability remarkably deteriorates. Therefore, the P content needs to be 0.2% or less, and preferably 0.1% or less. Further, since a grain diameter of a steel sheet according to the invention is 50 μm or more, if P is not encouragingly added, the steel sheet becomes exceedingly soft and its lower yield point becomes less-than 170 MPa a, which may cause poor handleability. As a consequence, it is preferable to set the lower yield point to be 170 MPa or more, and thus it is preferable to set the P content to be 0.05% or more.

S: When S content exceeds 0.01%, sulfide is formed and impedes the movement of a domain wall. In addition, the grain growability remarkably deteriorates. Accordingly, the S content is to be 0.01% or less. When the S content is 0.002% or less, preferably 0.001% or less, grain growability is particularly improved, and the loss factor is remarkably improved. Therefore, the S content is set preferably to be 0.002% or less, and more preferably to be 0.001% or less.

Al: Al is a deoxidizing element, which also gives a fine AlN deposition and controls grain growth. In order to acquire excellent grain growability, Sol. Al content is set preferably to be 0.004% or less. In case of utilizing a deoxidation effect, the Sol. Al content is preferably 0.1% or more so as to prevent AlN from coarsening and impeding the grain growability. When the Sol. Al content is 1.0% or more, however, the productivity is impeded, the cost increases, and thus ridging readily occurs. Therefore, the Sol. Al content is set to be less than 1.0%.

N: When an N content exceeds 0.005%, a precipitate is formed and impedes the movement of a domain wall. Therefore, the N content is set to be 0.005% or less, preferably 0.003% or less, but the less, the better possible.

The remainder includes Fe and inevitable impurities. Especially, an element such as Ti, Nb and Zr forms a fine precipitate and impedes grain growability, and thereby narrows a grain diameter. Consequently, the content of each element is preferably to be less, preferably less than 0.003%, and more preferably less than 0.001%.

### (2) Average Grain Diameter

Since the vibration is reduced by accelerating the movement of a domain wall in the damping alloy steel sheet of the invention, the smaller the grain boundary that impedes the domain wall movement is, that is, the larger the grain diameter is, the more preferable. .In order to move the domain wall effectively and obtain a high loss factor of 0.030 or more, the average grain diameter needs to be 50 μm or more. Meanwhile,. excessive growth in the grain diameter leads to orange peel while working, therefore the average grain diameter needs to be 300 μm or less.

### (3) Maximum Permeability

Another factor that impedes the movement of a domain wall is the plastic strain in grains, in addition to the above-mentioned precipitate and grain boundary. The plastic strain in grains is closely related with the maximum permeability. In order to reduce the plastic strain to a level at which it is substantially not an obstacle to the movement of a domain wall, and to obtain a high loss factor of 0.030 or more, the maximum permeability needs to be 4,000 or more.

### (4) Residual Induction

Furthermore, in the case where residual stress exists in a grain, since a positive magnetostrictive direction is oriented to a stress direction to ease the residual stress, and the magnetic domain structure freezes the damping capacity decreases. The residual stress in a grain is closely related with the residual induction. In order to reduce the residual stress to the level not being an obstacle to the movement of a domain wall, and to obtain a high loss factor of 0.030 or more, the residual induction needs to be 1.10 T or less.

### (5) Production Method

The damping alloy steel sheet of the invention can be produced by, for example, the method in which a steel having the element composition described above is hot-rolled, cold-rolled after pickling, and heated at a temperature of recrystallization temperature or higher to lower than an Ac₁ transformation point upon continuous annealing, and cooled under the tension of 0.1 to 4.9 MPa.

For the hot rolling, it is preferable that the steel is first heated to a temperature of 1,000 or higher to lower than 1,150° C., and then the rolling is conducted at a finishing temperature of 700° C. or higher. It is difficult to ensure the finishing temperature of 700° C. or higher when the heating temperature is 1, 000° C. or lower. When the heating temperature is 1,150° C. or higher, a small amount of impurities comes into a solid solution and finely recrystallizes upon hot rolling or following wind rolling, and thereby grain growability upon annealing may be impeded. In addition, the shape of plate or sheet is apt to deteriorate when the finishing temperature is lower than 700° C.

The hot-rolled sheet after hot rolling is pickled by a usual method, and subjected to cold rolling to obtain a cold-rolled sheet having a thickness of 2.0 mm or less, preferably 1.6 mm or less, as described above. When the thickness of the sheet exceeds 2.0 mm, strain generated in the sheet when passing through a line grows, and greater strain is introduced to the sheet by passing through a continuous annealing line after recrystallization or by passing through a leveling line followed thereafter, which leads to the lowering of the loss factor. From this point of view, the sheet thickness is set to be 2.0 mm or less, more preferably 1.6 mm or less. Furthermore, so as to assure rigidity as a constructional element, the thickness of the sheet is desirably to be over 0.5 mm. In ferromagnetic type damping alloy, the loss factor at a processing part deteriorates remarkably. Accordingly, light working, in other words, working into a flat sheet structure which is mainly a bending work is desirable. The thickness of ferromagnetic type damping alloy which is mainly constituted by a flat sheet structure is preferred to be over 0.75 mm, more preferred to be over 0.8 mm from the viewpoint of assuring rigidity.

Herein, annealing of a steel sheet normally includes continuous annealing and batch annealing. In case of batch annealing, the steel sheet is annealed with the sheet being coiled, a winding habit is formed while annealing, and thus shape straightening is needed to straighten the winding habit after annealing. At that time, plastic strain is introduced in a grain, the maximum permeability is reduced, and the loss factor is deteriorated. Therefore, annealing needs to be continuous annealing. A cold-rolled sheet after cold rolling is annealed so as achieve the average grain diameter of 50 to 300 μm, and for that the sheet needs to be heated at a temperature of from recrystallization temperature or higher to lower than Ac₁ transformation point. At a temperature of lower than the recrystallization temperature, since the plastic strain remains in a grain, the maximum permeability of 4,000 or more cannot be obtained. Also, at a temperature of Ac₁ transformation point or higher, a two-phase ferrite-austenite region or a single-phase austenite region is produced, and strain is given in a grain on ferrite transformation while cooling, thus it is not preferable. In addition, for annealing, a tension control is necessary upon cooling as described below.

In order to reduce residual stress in a grain after recrystallization, in a process of cooling-while annealing, tension provided to a steel sheet needs to be lowered. When the sheet is cooled while providing high tension, since a magnetic domain structure freezes in the manner of easing the stress of tension direction, the residual induction exceeds 1.10 T.

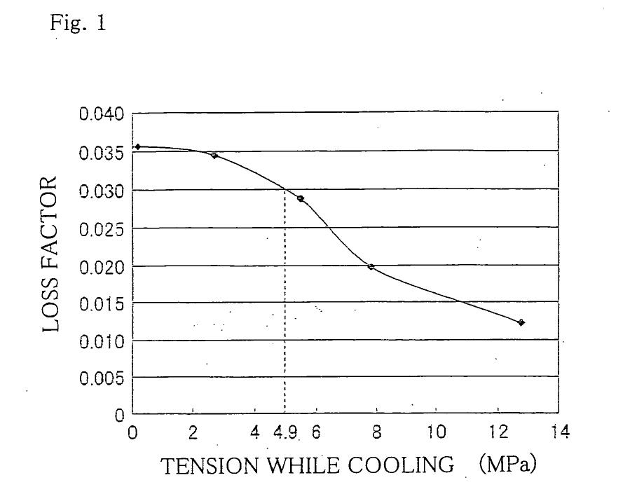

FIG. 1 shows a relationship between the tension while cooling and the loss factor. It can be realized that a high loss factor of 0.030 or more is obtained if the tension is 4.9 MPa or less. Further, the steel sheet meanders when the tension is extremely lowered, and thus the tension needs to be 0.1 MPa or more.

After annealing, it is desirable that leveling or temper rolling which may introduce plastic strain to lower the maximum permeability is not conducted. However, leveling or mild temper rolling which keeps maximum permeability of 4,000 or more can be conducted. In addition, the surface of steel sheet can be plated with-zinc, chromium, or nickel which improves corrosion resistance, within the range of satisfying the maximum permeability of 4,000 or more and the residual induction of 1.10 T or less.

### EXAMPLES

### Example 1

A steel slab containing the chemical composition within the range of the invention shown in Table 1 was reheated to 1,100° C., hot-rolled at a finishing temperature of 810° C., pickled, and cold-rolled to give a cold-rolled sheet having a thickness of 0.8 mm. Then, the sheet was continuously annealed at 880° C. for 2 minutes, and cooled to room temperature after changing the tension. The remainder which is not any of the chemical composition shown in Table 1 was Fe and inevitable impurities. In particular, Nb, Ti, and Zr were less than 0.001%, respectively. Furthermore, the recrystallization temperature was determined by annealing at temperature changed in every 20° C. in advance and observing the composition after the annealings, and it was confirmed that 880° C. is equal to or higher than the recrystallization temperature. Additionally, Ac₁ transformation point was calculated by thermodynamics, and it was confirmed that 880° C. is lower than the Ac₁ transformation point. A specimen which was 250 mm in length and 25 mm in width was cut out by machining from the cooled steel sheet. The specimen was vibrated with a grip having 50 mm in length and 200 mm in free length by the cantilever free damping method in accordance with JIS G 0602, measured the attenuation of amplitude with the use of a laser displacement meter, and the loss factor was obtained by the following equation:

Loss factor=1n(Xₖ/Xₖ₊₁)/π

in which Xₖ represents the k^{th} amplitude.

Furether, the loss factor depends on the amount of strain of a material upon vibration, the greatest loss factor in the measurement was given as the loss factor in each specimen. In addition, 4 strip specimens which were each 100 mm in length and 10 mm in width were cut out by machining to measure the maximum permeability and the residual induction (maximum exciting magnetic field 3183A/m) by the Epstein method in accordance with JIS C 2550(2000). In addition, the average grain diameter was measured by a cutting in accordance with JIS G 0552 (1₉₉₈) Also, the mechanical property was measured by a tensile test in accordance with JIS Z 2241 using JIS No. 5 tensile specimen whose rolling direction was a longer direction.

The result is shown in Table 2. It is found that when the tension while cooling was 4.9 MPa or less, the maximum permeability was 4,000 or more and the residual induction was 1.10 T or less to obtain a high loss factor of 0.030 or more. Meanwhile, the average grain diameter was not affected by the tension. All of them were 68 μm.

TABLE 1

| Chemical composition (mass %) | | | | | | | |
|---|---|---|---|---|---|---|---|
| C | Si | Mn | P | S | Sol. Al | N | Notes |
| 0.0025 | 0.10 | 0.13 | 0.005 | 0.003 | 0.12 | 0.0034 | Within Range |
| | | | | | | | of Invention |

TABLE 2

| | | | | Lower | |
|---|---|---|---|---|---|
| | Maximum | Residual | | Yield | |
| Tension | Perme- | Induction | Loss | Point | |
| (MPa) | ability | (T) | Factor | (MPa) | Notes |
| 0.2 | 6600 | 1.08 | 0.036 | 157 | Example of the |
| | | | | | Invention |
| 2.7 | 6700 | 1.09 | 0.035 | 160 | Example of the |
| | | | | | Invention |
| 5.5 | 6900 | 1.12 | 0.029 | 158 | Comparative |
| | | | | | Example |
| 7.8 | 7200 | 1.16 | 0.020 | 162 | Comparative |
| | | | | | Example |
| 12.7 | 7000 | 1.17 | 0.012 | 165 | Comparative |
| | | | | | Example |

### Example 2

With respect to the steel sheets cooled to room temperature with tension of 0.2 MPa as in Example 1, which were not subsequently, subjected to temper rolling (tension rate 0%) or which were subjected to the temper rolling with different tensions, the loss factor, magnetic property, average grain diameter and mechanical property were investigated in the same manner as in Example 1.

The result is shown in Table 3. When the tension rate was 2% or more, plastic strain was introduced into a grain to lower the maximum permeability, and thereby the loss factor of 0.030 or more could not be obtained. Meanwhile, the average grain diameter showed little change depending on the tension rate. All of them were between 66 and 69 μm.

TABLE 3

| | | | | Lower | |
|---|---|---|---|---|---|
| Tension | Maximum | Residual | | Yield | |
| rate | Perme- | Induction | Loss | Point | |
| (%) | ability | (T) | Factor | (MPa) | Notes |
| 0 | 6600 | 1.08 | 0.036 | 157 | Example of the |
| | | | | | Invention |
| 0.2 | 4800 | 0.99 | 0.031 | 165 | Example of the |
| | | | | | Invention |
| 2 | 2300 | 0.81 | 0.012 | 181 | Comparative |
| | | | | | Example |
| 5 | 1800 | 0.44 | 0.007 | 203 | Comparative |
| | | | | | Example |

### Example 3

A steel slab containing the chemical composition shown in Table 4 was reheated to 1,090° C., hot-rolled at a finishing temperature of 900° C., pickled, and cold-rolled to give a cold-rolled sheet having a thickness of 1.2 mm. Then, sheets A to I were each continuously annealed at 800° C. for 1 minute, and cooled to room temperature while providing a tension of 0.2 MPa. The remainder which is not any of -the chemical composition shown in Table 4 includes Fe and inevitable impurities. In particular, Ti and Zr were less than 0.001%, -respectively. Furthermore, the recrystallization temperature and the Ac₁ deformation point were obtained in the same manner as in Example 1, and it was found that 800° C. is equal to or higher than the recrystallization temperature and lower than the Ac₁ deformation point. With respect to the steel sheet after cooling, the loss factor, magnetic property, average grain diameter and mechanical property were investigated in the same manner as in Example 1.

The result is shown in Table 4. It is found that the cold-rolled sheets A, C, E, F, G, H and I, which had the chemical composition within the scope of the invention, are excellent in grain growability and have high loss factors of 0.0030 or more. In particularly, the cold-rolled sheets A and I whose S contents were as low as 0.001% or 0.0005% are extremely excellent in grain growability, and have extremely high loss factors of 0.040 or more. On the other hand, the cold-rolled sheet B whose C and S contents were outside the range of the invention, and the cold-rolled sheet D whose C content was outside the range of the invention and to which Nb was added are extremely poor in grain growability, and do not have high loss factors. The cold-rolled sheets C, F, G, H and I which were added with Si of 0.5% or more or P of 0.05% or more are excellent in handleability due to the high lower yield point of 170 MPa or more, while they have high loss factor of 0.030 or more, respectively.

TABLE 4

| | | | | | | | | | | | Resi- | | | |
|---|---|---|---|---|---|---|---|---|---|---|---|---|---|---|
| | | | | | | | | | Average | | dual | | Lower | |
| Cold- | | | | | | | | | Grain | Maximum | Induc- | | Yield | |
| rolled | Chemical composition (% by mass) | | | | | | | | Diameter | Perme- | tion | Loss | Point | |
| Sheet | C | Si | Mn | P | S | Sol. Al | N | Nb | (μm) | ability | (T) | Factor | (MPa) | Notes |
| A | 0.0025 | 0.10 | 0.13 | 0.005 | 0.001 | 0.001 | 0.0034 | <0.001 | 110 | 8900 | 0.99 | 0.041 | 153 | Example of the |
| | | | | | | | | | | | | | | Invention |
| B | 0.0500 | 0.01 | 0.15 | 0.003 | 0.022 | 0.040 | 0.0028 | <0.001 | 27 | 5200 | 1.13 | 0.016 | 251 | Comparative |
| | | | | | | | | | | | | | | Example |
| C | 0.0032 | 0.51 | 0.13 | 0.002 | 0.005 | 0.480 | 0.0031 | <0.001 | 87 | 7600 | 1.05 | 0.036 | 183 | Example of the |
| | | | | | | | | | | | | | | Invention |
| D | 0.0120 | 0.01 | 0.11 | 0.004 | 0.008 | 0.040 | 0.0025 | 0.016 | 24 | 4200 | 1.31 | 0.012 | 286 | Comparative |
| | | | | | | | | | | | | | | Example |
| E | 0.0028 | 0.01 | 0.12 | 0.003 | 0.007 | 0.001 | 0.0028 | <0.001 | 98 | 8200 | 1.02 | 0.039 | 148 | Example of the |
| | | | | | | | | | | | | | | Invention |
| F | 0.0021 | 0.89 | 0.15 | 0.003 | 0.005 | 0.001 | 0.0032 | <0.001 | 79 | 9200 | 1.01 | 0.035 | 206 | Example of the |
| | | | | | | | | | | | | | | Invention |
| G | 0.0033 | 0.01 | 0.13 | 0.120 | 0.004 | 0.001 | 0.0027 | <0.001 | 75 | 6400 | 1.03 | 0.034 | 201 | Example of the |
| | | | | | | | | | | | | | | Invention |
| H | 0.0028 | 0.91 | 0.14 | 0.091 | 0.003 | 0.001 | 0.0031 | <0.001 | 64 | 7700 | 1.02 | 0.031 | 232 | Example of the |
| | | | | | | | | | | | | | | Invention |
| I | 0.0029 | 0.88 | 0.14 | 0.087 | 0.0005 | 0.001 | 0.0029 | <0.001 | 175 | 14000 | 0.91 | 0.044 | 175 | Example of the |
| | | | | | | | | | | | | | | Invention |

1. A damping alloy steel sheet having a thickness of 2.0 mm or less, comprising:
an element composition of C: 0.005% or less, Si: less than 1.0%, Mn: 0.05 to 1.5%, P: 0.2% or less, S: 0.01% or less, Sol. Al: less than 1.0%, N: 0.005% or less, in terms of % by mass, and the remainder including Fe and inevitable impurities;
an average grain diameter of 50 to 300 μm;
a maximum permeability of 4,000 or more; and
a residual induction of 1.10 T or less.

2. The damping alloy steel sheet having a thickness of 2.0 mm or less according to claim 1, wherein Si is 0.5 or more to less than 1.0% in terms of % by mass in the element composition.

3. The damping alloy steel sheet having a thickness of 2.0 mm or less according to claim 1, wherein P is 0.05 to 0.2% in terms of % by mass in the element composition.

4. The damping alloy steel sheet having a thickness of 2.0 mm or less according to claim 1, wherein S is 0.002% or less in terms of % by mass in the element composition.

5. A method for producing a damping alloy steel sheet having a thickness of 2.0 mm or less,
in which a steel having the element composition of claim 1 is hot-rolled, cold-rolled after pickling, and heated at a temperature of recrystallization temperature or higher to lower than an Ac₁ transformation point during the continuous annealing, so as to give an average grain diameter of 50 to 300 μm; and cooled under tension of 0.1 to 4.9 MPa to give a maximum permeability of 4,000 or more and a residual induction of 1.10 T or less.

6. The damping alloy steel sheet having a thickness of 2.0 mm or less according to claim 2, wherein P is 0.05 to 0.2% in terms of % by mass in the element composition.

7. The damping alloy steel sheet having a thickness of 2.0 mm or less according to claim 2, wherein S is 0.002% or less in terms of % by mass in the element composition.

8. The damping alloy steel sheet having a thickness of 2.0 mm or less according to claim 3, wherein S is 0.002% or less in terms of % by mass in the element composition.

9. The damping alloy steel sheet having a thickness of 2.0 mm or less according to claim 6, wherein S is 0.002% or less in terms of % by mass in the element composition.

10. A method for producing a damping alloy steel sheet having a thickness of 2.0 mm or less, in which a steel having the element composition of claim 2 is hot-rolled, cold-rolled after pickling, and heated at a temperature of recrystallization temperature or higher to lower than an Ac₁ transformation point during the continuous annealing, so as to give an average grain diameter of 50 to 300 μm; and cooled under tension of 0.1 to 4.9 MPa to give a maximum permeability of 4,000 or more and a residual induction of 1.10 T or less.

11. A method for producing a damping alloy steel sheet having a thickness of 2.0 mm or less, in which a steel having the element composition of claim 3 is hot-rolled, cold-rolled after pickling, and heated at a temperature of recrystallization temperature or higher to lower than an Ac₁ transformation point during the continuous annealing, so as to give an average grain diameter of 50 to 300 μm; and cooled under tension of 0.1 to 4.9 MPa to give a maximum permeability of 4,000 or more and a residual induction of 1.10 T or less.

12. A method for producing a damping alloy steel sheet having a thickness of 2.0 mm or less, in which a steel having the element composition of claim 6 is hot-rolled, cold-rolled after pickling, and heated at a temperature of recrystallization temperature or higher to lower than an Ac₁ transformation point during the continuous annealing, so as to give an average grain diameter of 50 to 300 μm; and cooled under tension of 0.1 to 4.9 MPa to give a maximum permeability of 4,000 or more and a residual induction of 1.10 T or less.

13. A method for producing a damping alloy steel sheet having a thickness of 2.0 mm or less, in which a steel having the element composition of claim 4 is hot-rolled, cold-rolled after pickling, and heated at a temperature of recrystallization temperature or higher to lower than an Ac₁ transformation point during the continuous annealing, so as to give an average grain diameter of 50 to 300 μm; and cooled under tension of 0.1 to 4.9 MPa to give a maximum permeability of 4,000 or more and a residual induction of 1.10 T or less.

14. A method for producing a damping alloy steel sheet having a thickness of 2.0 mm or less, in which a steel having the element composition of claim 7 is hot-rolled, cold-rolled after pickling, and heated at a temperature of recrystallization temperature or higher to lower than an Ac₁ transformation point during the continuous annealing, so as to give an average grain diameter of 50 to 300 μm; and cooled under tension of 0.1 to 4.9 MPa to give a maximum permeability of 4,000 or more and a residual induction of 1.10 T or less.

15. A method for producing a damping alloy steel sheet having a thickness of 2.0 mm or less, in which a steel having the element composition of claim 8 is hot-rolled, cold-rolled after pickling, and heated at a temperature of recrystallization temperature or higher to lower than an Ac₁ transformation point during the continuous annealing, so as to give an average grain diameter of 50 to 300 μm; and cooled under tension of 0.1 to 4.9 MPa to give a maximum permeability of 4,000 or more and a residual induction of 1.10 T or less.

16. A method for producing a damping alloy steel sheet having a thickness of 2.0 mm or less, in which a steel having the element composition of claim 9 is hot-rolled, cold-rolled after pickling, and heated at a temperature of recrystallization temperature or higher to lower than an Ac₁ transformation point during the continuous annealing, so as to give an average grain diameter of 50 to 300 μm; and cooled under tension of 0.1 to 4.9 MPa to give a maximum permeability of 4,000 or more and a residual induction of 1.10 T or less.
